(19) United States
(12) Patent Application Publication
(10) Pub. No.: US 2006/0071548 A1
(43) Pub. Date: Apr. 6, 2006

(54) Method and system for early detecting the defects of an electrically controlled brake system

(75) Inventor: Werner Scheider, Monreal (DE)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: Lucas Automotive GmbH

(21) Appl. No.: 11/231,129

(22) Filed: Sep. 20, 2005

Related U.S. Application Data
(63) Continuation of application No. PCT/EP04/02905, filed on Mar. 19, 2004.

(30) Foreign Application Priority Data
Mar. 20, 2003 (DE) 103 12 481.0

(51) Int. Cl. B60T 8/88

(52) U.S. Cl. 303/122.04

(57) ABSTRACT

The invention relates to a method and a device for the early recognition of a possible failure of an electrically controlled brake system. For this purpose, the onboard power-supply voltage provided by a vehicle battery is checked for the purpose of early recognition of a possible failure of the electrically controlled brake system, in that an electrical load is switched on by a controller assigned to this load and, with the load in the switched-on state, checking of the vehicle battery is effected by means of a further controller. The result of the checking is used for the early recognition of a possible failure of the electrically controlled brake system in that, for example, it is made available to the vehicle driver in order that the latter is able to arrange in good time for replacement of the vehicle battery. A further measure consists in the switching-off of all non-safety-relevant high current-consumers in the motor vehicle.

### CROSS-REFERENCE TO RELATED APPLICATIONS

This application is a continuation of International Application No. PCT/EP2004/002905 filed Mar. 19, 2004, the disclosures of which are incorporated herein by reference, and which claimed priority to German Patent Application No. 103 12 481.0 filed Mar. 20, 2003, the disclosures of which are incorporated herein by reference.

### BACKGROUND OF THE INVENTION

The invention relates to the checking of an onboard power-supply voltage provided by a vehicle battery, performed for the purpose of the early recognition of a possible failure of an electrically controlled brake system.

Various methods are known for the detection of malfunctions or possible failures of vehicle components such as a vehicle battery. The vehicle battery is a particularly critical component in respect of its failure, since the service life of a battery is normally shorter than the lifetime of a vehicle. Consequently, a vehicle battery has to be replaced approximately three times per vehicle.

In the case of a failure of the vehicle battery, a supply of electric power to the onboard power supply is no longer reliably assured since, even in the case of travel in the lower speed range as, for example, in the case of urban travel, the charging capacity of the generator is not always sufficient to fully recharge the vehicle battery and attain the maximum voltage. For cost reasons, however, the majority of vehicle manufacturers does not favour the use of a second battery for maintaining the electric power supply. Since one of the most stringent safety requirements stipulates that an adequate, uninterrupted onboard power-supply voltage must be assured for electrically controlled brake systems such as, for example, electric parking brakes, permanent monitoring of the state of charge of the vehicle battery is absolutely essential.

A method and a device for ascertaining the onboard power-supply state of a motor vehicle are known from DE 198 45 562 C1, wherein a filtered or time-averaged voltage value is used to check the onboard power-supply state. A special evaluator is used for this purpose.

A further method and a device for ascertaining the onboard power-supply state are known from DE 198 45 565 C1. In the case of this method, voltage dips caused by short-time loads are not taken into account in an assessment of the onboard power-supply voltage, in that switched-on short-time loads are communicated to a voltage monitoring device in order that the voltage dips caused by these short-time loads are disregarded in the evaluation of the onboard power-supply voltage.

DE 198 45 561 C2 describes a method for fault recognition in an onboard power supply of a motor vehicle, in which the onboard power-supply voltage is compared with a setpoint voltage and, in the event of a deviation, it is ascertained, in a fault recognition device specially designed for the purpose, whether a generator load signal deviates from an associated value.

EP 0 800 955 A2, and corresponding U.S. Pat. No. 5,936,317, both of which are incorporated by reference herein, discloses a power-supply device for vehicles which calculates a consumption current consumed by a load unit. The power-supply device compares the calculated consumption current with a supply current supplied by a battery, and interrupts the supply current if the supply current is exceptionally large.

In the case of the method, described in DE 100 49 495 A1, for ascertaining the fitness for use of a battery in a motor vehicle, following commencement of starting-up there is ascertained the voltage U_{SE} at which the greatest voltage dip occurs. A chronologically succeeding voltage U₀₀ is ascertained at the instant at which the directly succeeding zero crossing of the current flowing through the battery occurs. The internal resistance of the battery is then ascertained, as a measure of its fitness for use, from the voltage difference between U₀₀ and U_{SE} and from an empirically ascertained relationship between the motor temperature and the power consumption of the starter motor.

WP 02/25794, and corresponding U.S. published patent application Ser. No. 2004/0021448, both of which are incorporated by reference herein, describes a method for regulating a generator in a motor vehicle having at least one battery, in which switch-over is effected between a recuperation readiness mode and a recovery mode in dependence on predefined switch-over conditions, a setpoint voltage being predefined in the recovery mode such that the battery is regenerated.

The invention is based on the object of creating a simple method and a system for the early recognition of a possible failure of an electrically controlled brake system.

### BRIEF SUMMARY OF THE INVENTION

This object and further objects according to the invention are achieved by a method and a system according to the independent claim(s). Further developments of the invention are disclosed by the dependent claims.

The result of the checking the onboard power-supply voltage provided by a vehicle battery is used for the early recognition of a possible failure of an electrically controlled brake system, e.g. of an electric parking brake (EPB) or of an electro-hydraulic or electromechanical brake system (EHB, EMB).

The method according to the invention is such that, upon recognition of a critical state of the vehicle battery, appropriate measures can be taken and, for example, arrangements can be made for replacement of the vehicle battery and/or a second vehicle battery can be activated in good time.

In a vehicle equipped with an electrically controlled brake system, various controllers may be networked together via a bus, preferably a CAN bus, installed in the vehicle, the controllers being able to communicate with one another via this bus. Alternatively, however, these controllers may also exchange information with one another via a wireless connection, e.g. via Bluetooth.

In order to check the onboard power-supply voltage, an electrical load is switched on by a first controller assigned to this load. This load may be, for example, an air-conditioning system or a heatable rear window, but it is also possible to use other electrical, preferably low-resistance, loads provided as standard in the motor vehicle.

Upon command from the controller assigned to this load, the load is preferably switched on briefly, without the need for this to be noticeable by the vehicle driver. If, for example, an air-conditioning system is switched on as an electrical load, the first controller is then the controller of the air-conditioning system (air-conditioning ECU). If the rear-window heating is used as an electrical load, the controller assigned to this function is used for switching on, although other devices in the vehicle may also be activated by the controllers assigned to these functions, such as, for example, the navigation system or an electrical adjustment of the passenger seat.

Checking of the vehicle battery is effected by means of a second controller, with the load in the switched-on state. This second controller is preferably the electronic controller of the electrically controlled brake system, thus, for example, the controller of the electric parking brake (EPB-ECU). This second controller checks the vehicle battery in order to be able to ascertain whether there is a risk of failure of the electric parking brake as a result of a variation of the battery capacity.

The result of the checking is preferably the measured onboard power-supply voltage value that can be made available by the second controller, via a vehicle bus, to a third controller, for the purpose of informing the driver of the vehicle. This third controller is preferably a controller for the instrument panel (instrument-panel ECU), although it would also be possible for the information to be forwarded to the navigation system or other controllers, with their assigned devices, that are installed in the vehicle, can be reached via the vehicle bus and are in contact with the vehicle driver via a communication channel.

The result of the checking may be communicated as information to a vehicle driver by the third controller. This may be effected by means of a visual signal which is displayed, for example, in the instrument panel, preferably as an LED display or a clear-text display. If there is differentiation between a correct function and a defective behaviour, a colour differentiation would also be possible. Likewise, an acoustic signal is conceivable. Indication is preferably also effected while the vehicle is in operation. Since the exchange of information is expediently effected via the CAN bus present in the vehicle, it is likewise possible to effect both further processing of the contained information and feedback with the instruction to perform further measurements, to have recourse to other loads for the measurement and to continue with further (e.g. cyclic) measurements.

The checking of the state of the vehicle battery may be performed with the use of cyclic measurements, in which case the cyclic measurements may be measurements at a predefined or variable interval of time. Instants for the measurement may be selected in dependence on a current battery capacity. The measurements may be effected at intervals of seconds or minutes and also, preferably, with the ignition switched off. It would also be conceivable to select another time interval or to establish a dependence on the average travel performance/time.

A predefined measure may be initiated on the basis of the measurement results obtained by means of the cyclic measurements, although a plurality of preferably simultaneous measures may also be effected. One of these measures may be, for example, warning of the vehicle driver prior to the occurrence of a critical state.

Further measures may be the switching-off of various current-consumers such as, for example, the air-conditioning system or a seat heating, although it is also possible to switch off all current-consumers which are not relevant to safety. It would be conceivable for this measure to be performed only when the ignition is switched off.

The current-consumers in the vehicle should, expediently, be divided into safety-relevant and non-safety-relevant current-consumers, it being possible for there to be different sequences for the switching-off of non-safety-relevant current-consumers, or a division according to electric power consumption. It may also be conceivable to take account of different seasons and times of day/night, since various current-consumers in winter perform a safety-relevant function that differs from that performed in summer. An air-conditioning system may be absolutely essential in winter in order to assure a full view through the front windscreen, whereas in summer the rear-window heating or the seat heating are vehicle components which are less relevant to safety.

Other advantages of this invention will become apparent to those skilled in the art from the following detailed description ofo the preferred embodiment, when read in light of the accompanying drawings.

### BRIEF DESCRIPTION OF THE DRAWINGS

FIG. 1 shows a simplified block diagram of a device for executing the method according to the invention;

FIG. 2 shows a more detailed block diagram of a preferred embodiment of the method according to the invention; and

FIG. 3 shows an exemplary application for cyclic measurements and measures resulting therefrom.

### DETAILED DESCRIPTION OF THE INVENTION

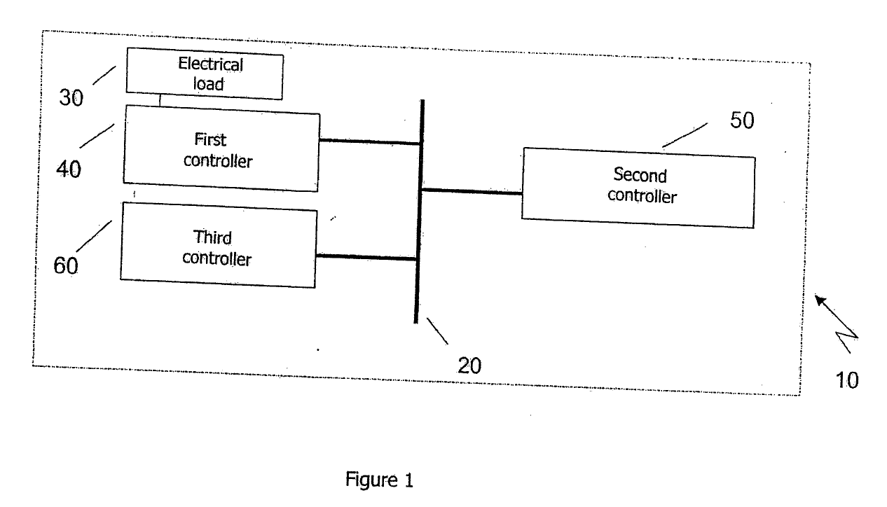

The block diagram represented in FIG. 1 shows, in schematic form, the interaction, by means of the communication via an existing CAN bus 20, of the various controllers in a vehicle 10 equipped with an electrically controlled brake system in the form of an EPB. The already existing controllers, which are networked together via the CAN bus 20, are used for early recognition of failure. In the case of the method according to the invention, use is made of an electrical load 30 and the first controller 40 assigned to it, and of a second controller 50, which communicates with a third controller 60 via the CAN bus 20.

In the context of early recognition of an EPB failure, the electrical load 30, being a current-consumer in the vehicle, is switched on by the first controller 40 assigned to it. While the electrical load is switched on, the second controller 50 checks the onboard power-supply voltage U_{Bat} and supplies the result of the checking to a third controller 60 via the CAN bus 20. The third controller processes the measurement result and initiates more extensive measures.

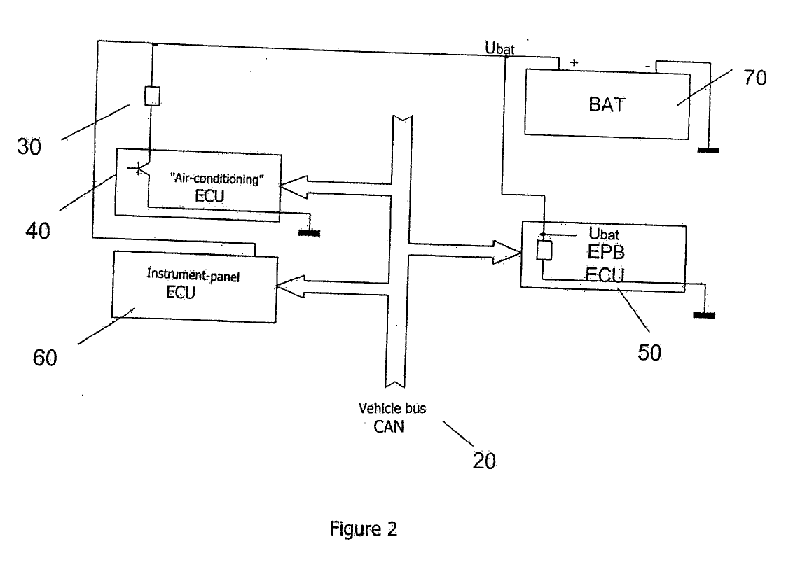

FIG. 2 shows a preferred embodiment of the device according to the invention. In this case, an air-conditioning system is used as an electrical load 30, with its assigned controller, the air-conditioning ECU 40. The controller of the electric parking brake EPB-ECU 50 which, via the CAN bus 20, exchanges information with the third controller 60, the instrument-panel ECU, is used as a second controller.

In a first step for early recognition of failure, an air-conditioning system is switched on by its controller, air-conditioning ECU 40. While the air-conditioning system is switched on, the controller of the electric parking brake EPB-ECU 50 is instructed to check the current onboard power-supply voltage U_{Bat} on the vehicle battery 70. Said controller, via the CAN bus 20, makes the result of the measurement available to the third controller 60, the instrument-panel ECU, for further processing and for the implementation of measures. A possible measure is that the vehicle driver receives information and can thus make arrangements in good time to replace the vehicle battery 70.

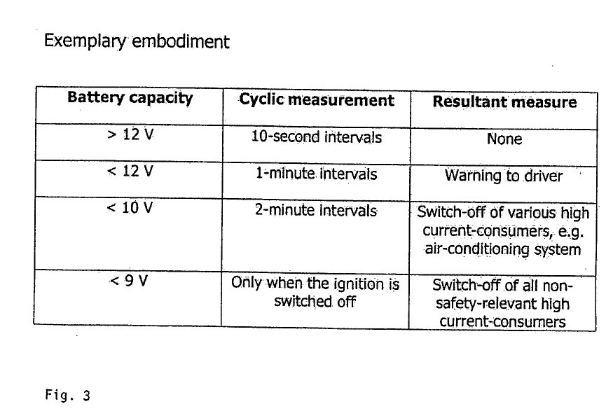

An embodiment for the definition of cycles for the measurements and the initiation of measures resulting therefrom is shown in FIG. 3. In order to prevent a failure of the electric parking brake resulting from an insufficient onboard power-supply voltage, various cycles for the measurements are proposed in this exemplary embodiment. Different measurements are performed, dependent on the measured voltage values. The voltage values have been divided into: more than 12 V, between 10 and 12 V, less than 10 V but more than 9 V, and less than 9 V. From these ensue both the period for the interval of the measurements, which are given in detail in FIG. 3, and the measures resulting therefrom.

As shown in FIG. 3, if the battery capacity is high, i.e. more than, for example, 12 V, cyclic measurement is performed at intervals of 10 seconds. This does not give rise to a resultant measure such as the provision of information to the vehicle driver since this, in the case of a full battery capacity of more than 12 V, is considered as an expected normal state.

If the battery capacity drops below 12 V, but does not fall below the voltage value of 10 V, cyclic measurement is performed at intervals of one minute. If the onboard power-supply voltage falls below the normal battery capacity down to 10 V, the driver is provided, for example, with visual information.

If the onboard power-supply voltage value is between 9 and 10 V, the time interval of the cyclic measurement is increased to, for example, two minutes, in order to reduce the current consumption, and a first precautionary measure is implemented in order that the vehicle battery is not loaded unnecessarily, and in order that the onboard power-supply voltage is not made to drop further. This precautionary measure includes the switching-off of various loads which have a high current consumption, such as, for example, the air-conditioning system, since it is not essential for an air-conditioning system installed in the vehicle to be switched on for safety-relevant operation.

If the battery capacity is less than 9 V, all non-safety-relevant current-consumers are switched off, in order to assure the functioning of the electronic parking brake until the battery is replaced. Further various cyclic checks of the vehicle battery, as well as measures directed at the current battery capacity, are performed.

In the case of a further preferred embodiment, the rear-window heating provided in the vehicle is used as an electrical load. The controller responsible for the rear-window heating briefly switches on the rear-window heating, this being unnoticed by the vehicle driver. While the rear-window heating is switched on, the battery capacity is checked by the controller of the electric parking brake. The result of the checking, the currently present onboard power-supply voltage value, is communicated, via the CAN bus, to the controller, the instrument-panel ECU, responsible for the instrument panel. If the voltage value is not in a critical state, i.e. if the onboard power-supply voltage value is 12 V or more, there is no need for further measures such as separate notification of the vehicle driver, since in this case the vehicle battery is in a fully functional state. The predefined measurement cycle of 10-second intervals is maintained. Since the measured onboard power-supply voltage value is the onboard power-supply voltage value that is normally to be expected, this is indicated by a visual display, e.g. in green. Upon dropping of the onboard power-supply voltage, orange and red warning displays are used in succession.

In the case of another development of the method according to the invention, the navigation system of the vehicle is switched on briefly, as an electrical load, by its controller, if this component is not in operation at the instant of checking. In order not to irritate the vehicle driver, a sound is emitted for a visual message, that a brief test is being conducted which does not impair the driving functions. The EPB-ECU performs the checking of the onboard power-supply voltage and communicates the result to the controller of the instrument panel. Should the measured voltage value be, for example, 9,5 volts, the ECB-ECU obtains the message that further cyclic measurements are to be performed at intervals of 2 minutes (FIG. 3). Since this voltage value is an onboard power-supply voltage value that must be taken seriously, the controllers of the current-consumers that are not absolutely essential for a fully functional, safe driving capability of the vehicle also obtain the message, via the CAN bus, to check a possible failure of the devices assigned to them. If the functioning of the air-conditioning system is not classified as absolutely essential on the basis of the measured outside temperature, this system is switched off first, as a first measure, in order to economize on the onboard power-supply voltage. In order to advise the vehicle driver of the existence of the critical situation, an acoustic signal also sounds, with a simultaneous warning display by an orange LED on the instrument panel, and an advice in the navigation system, that the onboard power-supply voltage value is 9.5 V and non-safety-relevant current-consumers are to be switched off by the vehicle driver, and that the battery is to be checked when the vehicle next stops.

In a further embodiment, the seat heating is switched on, as an electrical load, by its controller, and the EPB-ECU assumes the function of testing the vehicle battery. If, in the case of this embodiment, the result of the checking of the voltage is that the current battery capacity is already below a value of, for example, 8 V, immediate measures must be taken. The no longer acceptable onboard power-supply voltage value is again communicated directly to the controller, which further processes the data for the purpose of informing the vehicle driver. In the case of this example, the controller of the navigation system in the vehicle is used to inform the vehicle driver, and indication is effected both visually, by a red flashing LED, and by characters in the navigation system. An acoustic message is given with the instruction to note, when the vehicle next stops, that the safety of the electric parking brake is no longer assured, and that an immediate replacement of the battery must be arranged. In order that the existing onboard power-supply voltage can be maintained for ongoing operation up to this instant, all controllers of the non-safety-relevant current-consumers in the vehicle are instructed, via the CAN bus, to switch off these current-consumers or to switch them over to an emergency mode. Because of the overall emergency mode, further measurements continue to be performed only when the ignition has been switched off. In addition, when the vehicle next stops, the same message is again given to the vehicle driver, with the instruction to perform additional measures, such as parking the vehicle on level ground.

The invention can be used for the early recognition of a possible failure of an electrically controlled brake system, but the method could also be used in the case of other safety-relevant components in the vehicle for which an ongoing monitoring of the existing battery voltage is necessary in order to prevent a failure.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A method for the early recognition of a possible failure of an electrically controlled brake system by means of checking of the onboard power-supply voltage, the onboard power-supply voltage being provided by a vehicle battery, wherein, for the purpose of checking the onboard power-supply voltage,
an electrical load is switched on by means of a first controller assigned to this load;
checking of the vehicle battery is effected by means of a second controller, with the load in the switched-on state;
the result of the checking is used for the early recognition of a possible failure of the electrically controlled brake system.

2. The method according to claim 1, wherein the second controller is a controller of the electrically controlled brake system.

3. The method according to claim 1, wherein communication is effected between the controllers via a vehicle bus.

4. The method according to claim 1, wherein the result of the checking is the measured onboard power-supply voltage value.

5. The method according to claim 1, wherein the result of the checking is communicated to a vehicle driver.

6. The method according to claim 5, wherein the result is indicated by means of a visual signal in the instrument panel and by means of an acoustic signal.

7. The method according to claim 1, wherein the electrical load is an air-conditioning system, a heatable rear window or another load that is provided as standard.

8. The method according to claim 1, wherein the checking of the state of the vehicle battery is effected through the use of cyclic measurements.

9. The method according to claim 8, wherein the cyclic measurements are performed in dependence on a current battery capacity.

10. The method according to claim 8, wherein a predefined measure is initiated in dependence on the result.

11. The method according to claim 10, wherein the measure is a switching-off of current-consumers.

12. (canceled)

13. A system for executing the method according to claim 1 for the early recognition of a possible failure of an electrically controlled brake system by means of checking of an onboard power-supply voltage, which system comprises the electrically controlled brake system, a vehicle battery which provides the onboard power-supply voltage, an electrical load switched on by a first controller, and a second controller for checking the onboard power-supply voltage of the vehicle battery when the load is in the switched-on state, the result of the checking of the onboard power-supply voltage being used for the early recognition of a possible failure of the electrically controlled brake system.

14. The method according to claim 5, wherein the result is indicated by means of a visual signal in the instrument panel or by means of an acoustic signal.
